(19) United States
(12) Patent Application Publication
(10) Pub. No.: US 2007/0162493 A1
(43) Pub. Date: Jul. 12, 2007

(54) Business object duplicates

(76) Inventors: Matthias Schmitt, Speyer (DE); Clemens Jacob, Ludwigshafen (DE); Carsten Kohler, Muhlhausen (DE); Joachim Puteick, Ubstadt-Weiher (DE); Hendrik Geipel, Walldorf (DE); Heike Berger, Oberhausen-Rheinhausen (DE); Martin Rogge, Ostringen (DE); Mathias Schonecker, Hambrucken (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,574

(22) Filed: Dec. 30, 2005

(51) Int. Cl. G06F 17/00

(52) U.S. Cl. 707/103 R

(57) ABSTRACT

A system includes a first business object of a first type having a first set of attributes, and a second business object of a second type having a second set of attributes. A portion of the first set of attributes and a portion of the second set of attributes are common to both the first business object and the second business object. The system also includes a common key for both the first business object and the second business object. A user can access either the first business object or the second business object using the common key.

### BACKGROUND

Doing business today is much different than doing business a generation ago. A generation ago, businesses were more or less autonomous. However, these days, ever dwindling margins and increased pressure for profits require many businesses to create very close relations with outside parties that specialize in certain services and goods. In many industries, companies have to create close ties with outside parties in order to survive. As an example, a business may rely on an outside provider to manage inventory. In other business settings, a supplier may be manufacturing and delivering a key component vital to the manufacture of a product for the company. It is very common for such a supplier to be supplying the key component on a “just in time” basis. The company will have a very close relation to such a supplier. The relation will be so close as to almost be considered an extension of the company, even though they are really another entity separate from the company. In this example, the supplier's inventory may be monitored by the company in order to assure that an adequate supply of the key component is available to keep production running smoothly. In another situation, not only may the inventory be monitored but an automatic ordering system may be in place so that the supplier may quickly respond to a need to ramp up manufacture of the key component to meet an increased demand for the product. In some companies, especially larger companies, it is not uncommon to have many of these suppliers or vendors so closely related to the company so as to be an extension of the enterprise.

Another common theme in business is that a business tends to do business with those they also do business with. Therefore, some of the closely related companies quite commonly are also customers of the company. A large company generally will try to know as much as possible about their customers, however, what they need to know is generally much different than what they need to know about a closely related supplier that is also treated like an extension of the enterprise. When a closely tied company is also a customer, one of the business challenges includes how to treat a closely tied company when in another role and how to manage information related to the closely tied company in each of their roles.

### BRIEF DESCRIPTION OF THE DRAWINGS

FIG. 1 is a block diagram of an overall computing environment, according to an example embodiment.

FIG. 2 is a display of a model of a business object, according to an example embodiment.

FIG. 3 is a ven diagram showing the various types of relationships a business or enterprise has with various customers, vendors, and other organizations, according to an example embodiment.

FIG. 4 is a schematic view of a first type business object, and a second type of business object for an organization that has both types of relationships with an enterprise or business, according to an example embodiment.

FIG. 5 is a model of a first type business object, a second type of business object, and an access point, according to an example embodiment.

FIG. 6 is a flow diagram of a method for handling a single party located in two types of business objects, according to an example embodiment.

FIG. 7 is a schematic of a computer system that executes programming, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

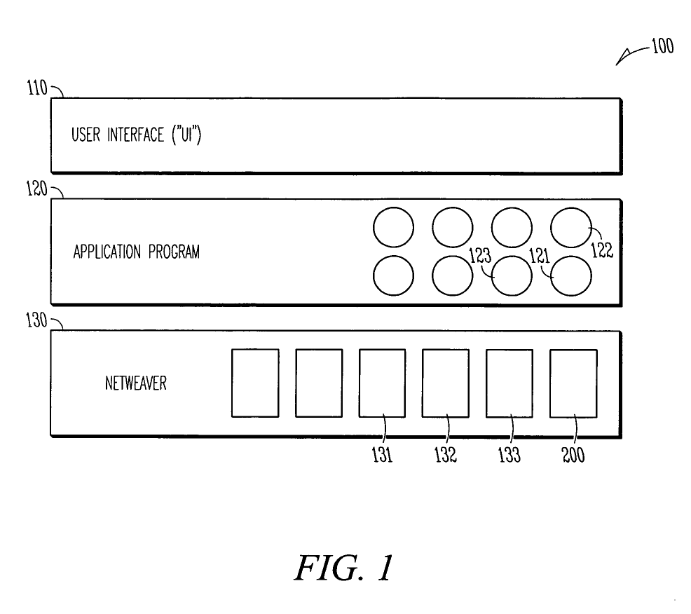

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123. The object is a technical representation of a concept that includes data and logic. In one example embodiment, the object, such as object 131, 132, 133 is referred to as a business object and is a technical representation of a business concept that includes data and logic.

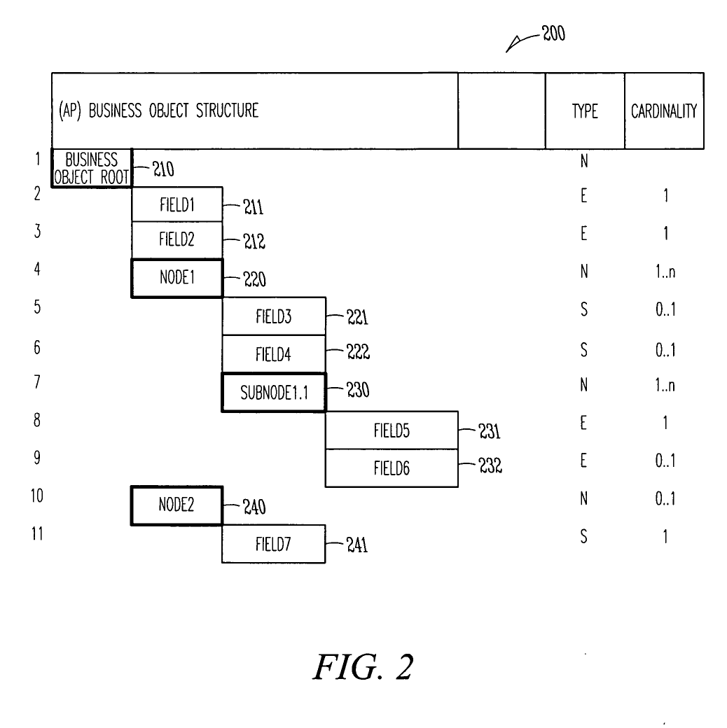

FIG. 2 is a display of a model 200 of a business object, such as business object 121, according to an example embodiment. A business object or object has a structure that includes a root 210, nodes such as nodes 220 and 240, and a sub node 230. Associated with a business or a root 210 is a grouping of information related to the business object root or root 210. Some of the information is held in fields such as 211 and 212. The information is also held in a node 220 which in turn also represents a grouping of information such as data and logic which are held in fields 221 and 222. Also under the root 210 and node 220 is a sub node 230. Sub node 230 holds another grouping of information that includes data and logic that are held in fields 231, 232. The business object 200 also includes another node 240. Node 240 is at the same level as node 220 and includes another grouping of data and logic which includes field 241. Therefore, it is seen that object 200 or business object 200 has a structure which includes a root 210, nodes, such as nodes 230 and 240, and sub nodes, such as sub node 230. It should be noted that FIG. 2 shows a simplified example of the structure of an object or business object 200. In actuality, a business object or object 200 may have a more complex structure. However, the principles as set forth in FIG. 2 will be followed where each root, node and/or sub node includes a grouping of information that can include data and logic.

In some embodiments, the structure of the business object or an outline of the business object is used to form a model of the business object 200. A model is useful for the purposes of designing and programming in a business object, such as business object 200. A model of the business object 200 shows the structure. In some embodiments, the model is referred to as a template. A template or model can take on any form just so it shows the structure of the object or business object 200. As shown in FIG. 2, the template is formed on a spreadsheet, such as an Excel spreadsheet. Excel is a registered trademark of Microsoft Corporation.

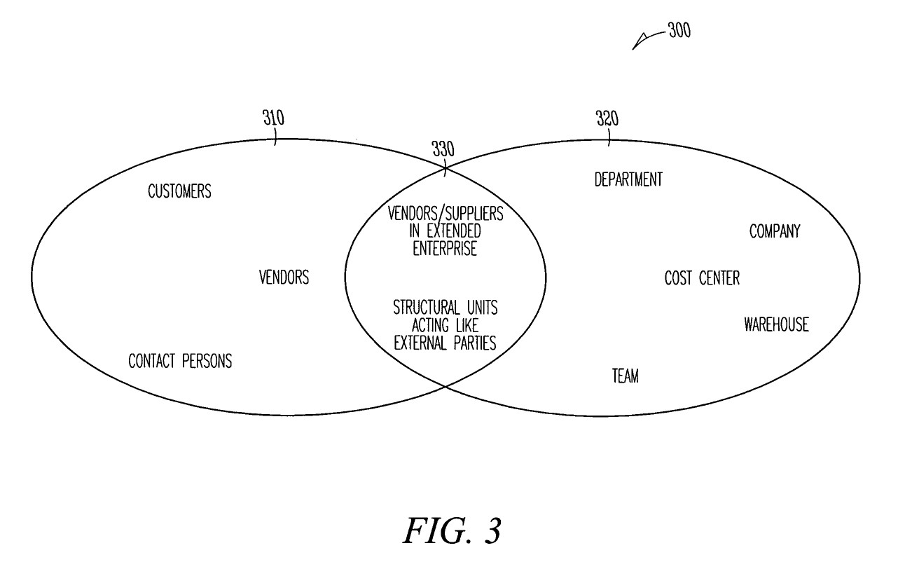

FIG. 3 is a ven diagram 300 of an entire set of different types of relationships 300 a business or enterprise will have. The first set 310 of types of relationships include types of legal or natural persons in which the enterprise is interested in from a business perspective. These are legal or natural persons that the enterprise or business is interested in doing business with. These are generally legal or natural persons that are dealt with at arm's length. In other words the legal or natural persons are close enough to do business but there is not an intimate relationship between the legal or natural person and the enterprise or company. For example, there is no need to know the structure or the inner workings of the legal or natural person other than the knowledge needed in order to buy supplies from these legal or natural people or to sell products to these legal or natural people. These legal or natural people are termed business partners and are, simply, legal or natural people with whom the company or enterprise is doing business.

The ven diagram 300 also includes a second set of relationships 320. These are legal or natural people and organizations within the company or enterprise with whom the business or enterprise has very intimate relationships. These relationships are key to running the enterprise. These relationships include various departments, teams, cost centers, warehouses and other companies the enterprise or company has teamed up with in order to conduct business. The relationships the company or enterprise has with organizations in the second group of relationships 320 is very close. Generally, in order to maintain any type of competitive advantage, the relationships between the company or enterprise represented by the second group require intimate knowledge of the organization and its structure. In some instances, the organizations in this second group 320 are portions of the company. In other instances, these organizations may be outside companies, such as vendors or suppliers or other service providers. Those organizations in the second group 320 are very close organizations, or very close customers or vendors with whom a company is working so closely that the company must have information on the internal structures of the organization, customer or vendor. Generally, organizations, customers and vendors within the second group are part an extension of the enterprise or business. Some term these organizations as part of the extended enterprise.

The ven diagram 300 also includes an area 330 that include some organizations that have both types of relationships. In other words, the organizations, customers or vendors in the area 330 sometimes act as a business partner and are therefore part of the first set of relationships 310 and also sometime act as part of the extended enterprise and are therefore part of the second set of relationships 320. The organizations, customers or suppliers in the area 330 generally includes customers or vendors that are part of the extended enterprise and therefore having a very close relationship with the company or business, and whom the business also treats sells or buys products from. The organizations, customers or suppliers in the area 330 also include organizations within the company that also buy from the business or enterprise. In other words, at times these organizations wear the hat or act as customers or vendors which conduct business at arms length with the business or enterprise, and at other times these organizations wear another hat or act as part of the extended enterprise with whom the business or enterprise has intimate knowledge of the inner workings and structure of the organization.

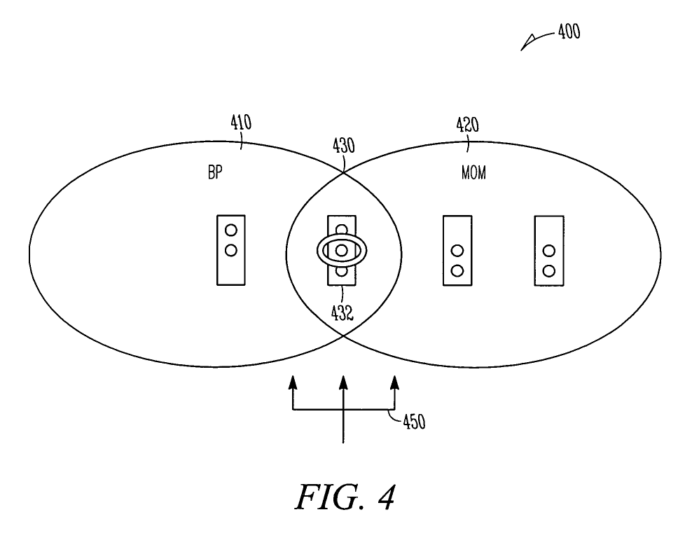

FIG. 4 is a schematic view of a first type business object, and a second type of business object for an organization that has both types of relationships with an enterprise or business, according to an example embodiment. Generally, legal or natural persons in the first realm or world that have the type of relationship of the first group 310 in the ven diagram (see FIG. 3) are represented in a first type of business object 410 and the types of organizations in the second realm or world that have the type of relationship of the second group 320 in the ven diagram (see FIG. 3) are represented by a second type of business object 420. The first type of business objects 410 are generally known as business partner business objects. The second type of business objects 420 are generally known as master organization management business objects. When an organization, legal or natural person, customer, vendor or outside company has only one relationship and is clearly in either the first group 310 or in the second group 320, a business object modeled like the business object 200 defines the relationship as well as the information and processes associated with the relationship. In other words, when an organization, legal or natural person, customer, vendor or outside company is only a customer or vendor, the relationship is represented by a business partner business object or first type of business object 410. When an organization, legal or natural person, customer, vendor or outside company has only in the relationship of being part of the extended enterprise or business, the relationship is represented by a master organization management business object or second type of business object 420.

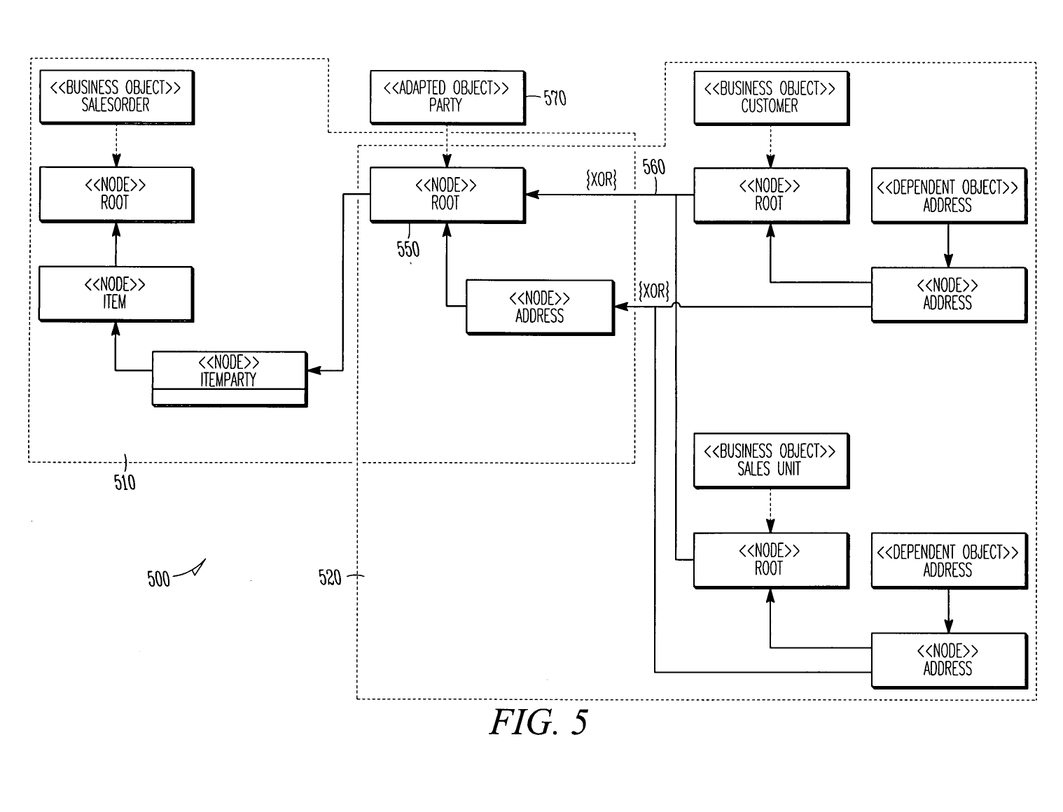

FIG. 4 shows a business organization structure for an organization, legal or natural person, customer, vendor or outside company has both the first type of relationship 310 and the second type of relationship 320 with the business or enterprise. In other words, FIG. 4 shows a business organization structure for an organization, legal or natural person, customer, vendor or outside company that sometimes is best represented by a business partner business object 410 and sometimes is best represented by a master organization business object 420. Each type of business object 410, 420 includes information and processes that are different and define the relationship 310, 320 respectively. The information and processes of the business object 410 are the attributes 412. The information and processes of the business object 420 are the attributes 422. Put another way, there are attributes 412 associated with the organization, legal or natural person, customer, vendor or outside company that define the first type of relationship 310 in the business partner business object 410. There are a different set of attributes 422 associated with the organization, legal or natural person, customer, vendor or outside company that define the second type of relationship 320 in the master organization management business object 420. For a single organization, legal or natural person, customer, vendor or outside company some of the attributes for the business partner business object 410 and some of the attributes for the master organization management business object 420 are the same 432. These attributes 432 tend to be information such as the name and address of the organization, legal or natural person, customer, vendor or outside company. Other attributes 432 may also be common to both the business partner business object 410, and the master organization management business object 420. Rather than repeat these common attributes 432 in each of the business objects or rather than carry all the attributes for each type of business object in both the business partner business object 410, and the master organization management business object 420, a special structure is provided. The special structure, detailed in FIG. 5, includes a single access point 450 to both the business partner business object 410, and the master organization management business object 420. A user can access the common attributes 432 using the access point 450. In addition, the user can view either the business partner business object 410 or the master organization management business object 420 via the access point 450.

FIG. 5 is a model 500 of a first type business object 510, a second type of business object 520, and an access point 550, according to an example embodiment. The model 500 is a model of a portion of a system, such as computer system 100 (see FIG. 1). The model 500 includes a common key 550 for both the first business object 510 and the second business object 520. A user can access either the first business object 510 or the second business object 520 using the common key 550. In one example embodiment, the common key is an identifier, such as a globally unique identifier. In another example embodiment, the system further includes a link 560 that links the first business object 510 and the second business object 520. The system also includes a party facade 570 for entering or changing the common attributes of the first business object 510 and the second business object 520. The party facade 570 can also be used to view the first business object 510 or view the second business object 520. In some example embodiments, the common attributes of the first business object and the second business object includes a party. In still other embodiments, the relationship represented by the first business object 510 is an external view of the party, and the relationship represented by the second business object 520 is an internal view of the party. The relationship represented by the second business object 520, in some example embodiments, is as an extension of an enterprise. The relationship represented by the first business object 510, in other example embodiments, is as a customer or a vendor.

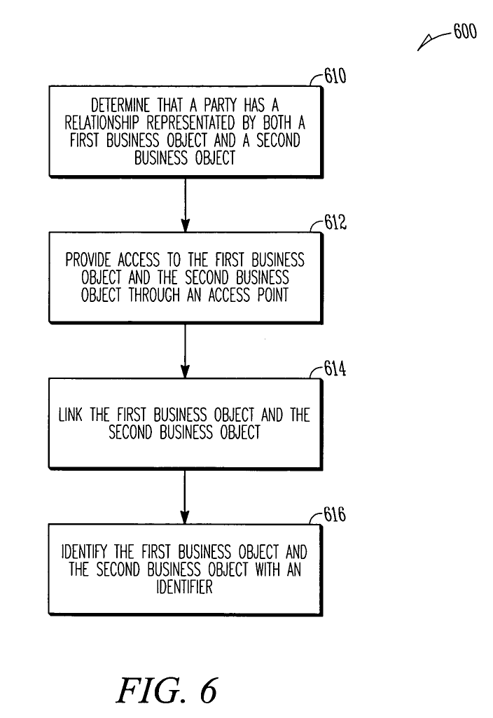

FIG. 6 is a flow diagram of a method 600 for handling a single party located in two types of business objects, according to an example embodiment. The method 600 includes determining that a party has a relationship represented by both a first business object and a second business object 610, and providing access to the first business object and the second business object through an access point 612. In some embodiments, the access point is a single access point. Providing access to the first business object and the second business object through a single access point 612 includes providing separate views of the first business object and the second business object. In some embodiments, the views of the first business object and the second business object are viewable at a user interface. In still other example embodiments, providing access to the first business object and the second business object 612 includes providing access to attributes common to both the first business object and the second business object. The method 600 also includes linking the first business object and the second business object 614. The method 600 can also include identifying the first business object and the second business object with an identifier 616.

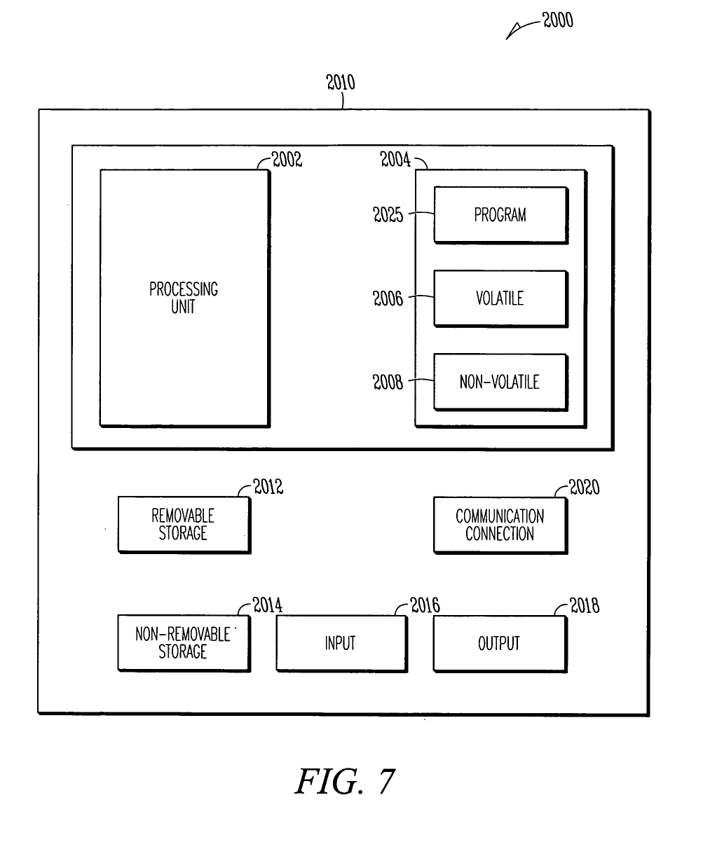

A block diagram of a computer system 2000 that executes programming for performing the above algorithm is shown in FIG. 7, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A machine-readable medium includes a set of instructions that, when executed by a machine, perform the method of determining that a party has a relationship represented by both a first business object and a second business object 610, and providing access to the first business object and the second business object through an access point 612. In some embodiments, the machine-readable medium of includes further instructions that, when executed by a machine, also perform identifying the first business object and the second business object with an identifier 616.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A system comprising:
a first business object of a first type having a first set of attributes;
a second business object of a second type having a second set of attributes, wherein a portion of the first set of attributes and a portion of the second set of attributes are common to both the first business object and the second business object; and
a common key for both the first business object and the second business object.

2. The system of claim 1 wherein a user can access either the first business object or the second business object using the common key.

3. The system of claim 1 wherein the common key is an identifier.

4. The system of claim 1 wherein the common key is a globally unique identifier.

5. The system of claim 1 further comprising a link that links the first business object and the second business object.

6. The system of claim 1 further comprising:
a link that links the first business object and the second business object; and
a party facade for entering the common attributes of the first business object and the second business object.

7. The system of claim 1 wherein the common attributes of the first business object and the second business object is a party.

8. The system of claim 7 wherein
the relationship represented by the first business object is an external view of the party, and
the relationship represented by the second business object is an internal view of the party.

9. The system of claim 8 wherein the relationship represented by the second business object is as an extension of an enterprise.

10. The system of claim 8 wherein the relationship represented by the first business object is as a customer.

11. The system of claim 8 wherein the relationship represented by the first business object is as a vendor.

12. A method comprising:
determining that a party has a relationship represented by both a first business object and a second business object; and
providing access to the first business object and the second business object through an access point.

13. The method of claim 12 wherein the access point is a single access point.

14. The method of claim 12 wherein providing access to the first business object and the second business object through a single access point includes providing separate views of the first business object and the second business object.

15. The method of claim 14 wherein the views of the first business object and the second business object are viewable at a user interface.

16. The method of claim 12 further comprising linking the first business object and the second business object.

17. The method of claim 12 wherein providing access to the first business object and the second business object platform includes providing access to attributes common to both the first business object and the second business object.

18. The method of claim 12 further comprising identifying the first business object and the second business object with an identifier.

19. A machine-readable medium including a set of instructions that, when executed by a machine, perform the method of
determining that a party has a relationship represented by both a first business object and a second business object; and
providing access to the first business object and the second business object through an access point.

20. The machine-readable medium of claim 19 including further instructions that, when executed by a machine, also perform identifying the first business object and the second business object with an identifier.
